(19) United States
(12) Patent Application Publication
(10) Pub. No.: US 2006/0131769 A1
(43) Pub. Date: Jun. 22, 2006

(54) Pre-polymer extraction using a super-cooled fluid

(75) Inventors: Sanjay Rastogi, Rochester, NY (US); Mahendra Nandu, Pittsford, NY (US); Gary Friends, Ontario, NY (US)

Correspondence Address: Bausch & Lomb Incorporated, One Bausch & Lomb Place, Rochester, NY, 14604-2701, US

(73) Assignee: Bausch & Lomb Incorporated

(21) Appl. No.: 11/314,510

(22) Filed: Dec. 21, 2005

Related U.S. Application Data
(60) Provisional application No. 60/638,893, filed on Dec. 22, 2004.

(51) Int. Cl. B29D 11/00

(52) U.S. Cl. 264/2.6; 264/28; 264/85; 264/334; 264/236

(57) ABSTRACT

The present invention is a process for extracting pre-polymer from a polymer lens. The process comprises the step of contacting the lens with a super-cooled solvent for a period of time sufficient to extract pre-polymer from the polymer lens.

### CROSS REFERENCE

This application claims the benefit of Provisional Patent Application No. 60/638,893 filed Dec. 22, 2004 and is incorporated herein by reference.

### BACKGROUND OF THE INVENTION

1. Field of the Invention

The present invention relates to extraction of pre-polymer using a super-cooled fluid.

2. Discussion of Related Art

Most contact lenses are molded in disposable polyethylene or polypropylene molds. Specifically, a contact lens is made of two mold halves. The anterior mold half defines the convex surface of the contact lens. The posterior mold half defines the concave surface of the contact lens. During the molding process, a predetermined amount of a pre-polymer mixture is placed in the anterior mold half. The posterior mold half is pressed against the anterior mold half forming the desired shape of the contact lens. After the mold halves are placed together a curing step occurs. In one embodiment, the curing step occurs by application of ultraviolet light that catalyzes a polymerization reaction.

The contact lens is removed from the two disposable mold halves and further processed and packaged. The need for further processing depends in large part upon the nature of the lens that results from the molding process. Typical contact lenses that are cured with ultraviolet light will have unreacted pre-polymer entrained in the polymer matrix. The unreacted pre-polymer is preferably removed before the contact lens is packaged for use. Typically, the extraction occurs by contacting the contact lens that has been molded with a solvent that extracts the pre-polymer.

In one embodiment, isopropyl alcohol is used to extract the pre-polymer. However, isopropyl alcohol requires expensive recycling or waste disposal as an organic solvent. Furthermore, both water extraction and extraction of pre-polymer with isopropyl alcohol are time consuming.

It would be an advantage to shorten the time required to extract a pre-polymer and/or alternatively eliminate the need for disposal or recycling of an organic solvent. The present invention addresses these and other needs.

### SUMMARY OF THE INVENTION

The present invention of one embodiment includes a process for extracting pre-polymer from a polymer lens typically an ophthalmic lens including an intraocular lens or a contact lens. The process comprises contacting the lens with a super-cooled solvent for a period of time sufficient to extract pre-polymer from the polymer lens. The super-cooled fluid evaporates into the air without the need for recycling. Moreover, the processing step for extracting pre-polymer with a cryogenic fluid takes less time. The number of rinse stages of hydration can be reduced by pre-polymer extraction—saving time and money.

In another embodiment, there is a process for making a contact lens. The process comprises providing a mold that has an anterior mold half and a posterior mold half. The mold is filled with a pre-polymer. The pre-polymer is cured to form a contact lens. The anterior mold half is separated from the posterior mold half. At least one of the anterior mold half and the posterior mold half is separated from the contact lens. The contact lens is contacted with a cryogenic solvent for a period of time sufficient to extract pre-polymer from the contact lens. Thereby, a cryogenic solvent cleans the contact lens and extracts pre-polymer from the contact lens.

In another embodiment, there is an ophthalmic, including a contact lens, made by a process comprising the steps of polymerizing an ophthalmic lens from pre-polymer material and contacting the ophthalmic lens with a cryogenic solvent for a period of time sufficient to extract pre-polymer from the ophthalmic lens.

In still another embodiment, there is a process for cleaning an ophthalmic lens. The process comprises contacting the entire surface of the ophthalmic lens with a cryogenic fluid.

In yet another embodiment there is a process for manufacturing an ophthalmic lens, comprising the steps of: forming the ophthalmic lens in a mold; removing the ophthalmic lens from the mold; and contacting the entire surface of the ophthalmic lens with a super-cooled fluid.

### DETAILED DESCRIPTION OF THE INVENTION

One method in practice for making ophthalmic lenses including contact lenses and intraocular lenses is cast molding. Cast molding of ophthalmic lenses involves depositing a curable mixture of polymerizable lens materials, such as pre-polymers, in a mold cavity formed by two assembled mold sections, curing the mixture, disassembling the mold sections and removing the molded lens. As used herein, the term “pre-polymer” and like terms denote compounds that are inserted into a contact lens mold to be polymerized by free radical polymerization, the term includes monomers and macromonomers and related terms.

Other post-molding processing steps may also be employed. Representative cast molding methods are disclosed in U.S. Pat. Nos. 5,271,875 (Appleton et al.); 4,197,266 (Clark et al.); 4,208,364 (Shepherd); 4,865,779 (Ihn et al.); 4,955,580 (Seden et al.); 5,466,147 (Appleton et al.); and 5,143,660 (Hamilton et al.).

Cast molding occurs between a pair of mold sections. Typically, one mold section, referred to as the anterior mold section forms the anterior, convex, optical surface of the ophthalmic lens. The other mold section, referred to as the posterior mold section, forms the posterior, concave, optical surface of the ophthalmic lens. The anterior and posterior mold sections are generally complimentary in configuration.

Typically, a predetermined amount of a liquid mixture including uncured pre-polymer and solvent is placed in the anterior mold section. The posterior mold section is placed over the anterior mold section and takes the shape of the contact lens. If the desired lens is aspheric, the posterior mold section must be axially positioned relative to anterior mold halve to create proper aspheric shape. The predetermined amount is slightly greater than the volume of the contact lens mold. A small portion of the pre-polymer mixture overflows in a radially spaced apart overflow reservoir that surrounds the circumference of the contact lens. Then, the lens is cured by a curing technique such as exposure to ultraviolet radiation.

Once the lens is formed, the mold sections are separated and the molded lens is removed in a multi-step process. The anterior and posterior mold sections are usually used only once for casting a lens prior to being discarded due to the significant degradation of the optical surfaces of the mold sections that often occurs during a single casting operation.

Materials

Hydrogels represent one class of materials used for many device applications, including ophthalmic lenses that are made by the molding process. Hydrogels comprise a hydrated, cross-linked polymeric systems containing water in an equilibrium state. Accordingly, hydrogels are copolymers prepared from hydrophilic pre-polymers. In the case of silicone hydrogels, the hydrogel copolymers are generally prepared by polymerizing a mixture containing at least one device-forming silicone-containing pre-polymer and at least one device-forming hydrophilic pre-polymer. Either the silicone-containing pre-polymer or the hydrophilic pre-polymer may function as a crosslinking agent (a crosslinking agent being defined as a pre-polymer having multiple polymerizable functionalities), or alternately, a separate crosslinking agent may be employed in the initial pre-polymer mixture from which the hydrogel copolymer is formed. Silicone hydrogels typically have a water-content between about 10 to about 80 weight percent.

Examples of useful device-forming hydrophilic pre-polymers include: amides such as N,N-dimethylacrylamide and N,N-dimethylmethacrylamide; cyclic lactams such as N-vinyl-2-pyrrolidone; (meth)acrylated alcohols, such as 2-hydroxyethylmethacrylte and 2-hydroxyethylacrylate; and (meth)acrylated poly(alkene glycols), such as poly(diethylene glycols) of varying chain length containing monomethacrylate or dimethacrylate end caps. Still further examples are the hydrophilic vinyl carbonate or vinyl carbamate pre-polymers disclosed in U.S. Pat. Ser. Nos. 5,070,215, and the hydrophilic oxazolone pre-polymers disclosed in U.S. Pat. Ser. No. 4,910,277, the disclosures of which are incorporated herein by reference. Other suitable hydrophilic pre-polymers will be apparent to one skilled in the art.

As mentioned, one preferred class of medical device materials is silicone hydrogels. In this case, the initial device-forming pre-polymer mixture further comprises a silicone-containing pre-polymer.

Applicable silicone-containing pre-polymer materials for use in the formation of silicone hydrogels are well known in the art and numerous examples are provided in U.S. Pat. Ser. Nos. 4,136,250; 4,153,641; 4,740,533; 5,034,461; 5,070,215; 5,260,000; 5,310,779 and 5,358,995.

Another class of silicon-containing pre-polymers includes polyurethane-polysiloxane macromonomers (also sometimes referred to as pre-polymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers.

Other examples of materials that may be used in the manufacture of contact lenses according to the present invention are found in U.S. Pat. Ser. Nos. 5,908,906 to Künzler et al.; 5,714,557 to Künzler et al.; 5,710,302 to Künzler et al.; 5,708,094 to Lai et al.; 5,616,757 to Bambury et al.; 5,610,252 to Bambury et al.; 5,512,205 to Lai; 5,449,729 to Lai; 5,387,662 to Künzler et al. and 5,310,779 to Lai; the disclosures of which are incorporated herein by reference.

In another embodiment, the materials molded form hard contact lenses including rigid gas permeable lenses. Examples of conventional RGP materials are well known in the art and include silicone acrylate copolymers and fluorosilicon acrylate copolymers. Representative silicone acrylate RGP materials include copolymers of a siloxane (meth) acrylate monomer (such as tris(trimethylsiloxy) silylpropyl methacrylate), a hydrophilic wetting monomer (such N-vinyl pyrrolidone or methacrylic acid), a crosslinking monomer (such as monomers having two terminal (meth) acrylate radicals) and a hardening monomer (such as methyl methacrylate or dimethyl itaconate). Fluorosilicon acrylate RGP materials include a fluorinated co-monomer; for example, a fluorinated (meth) acrylate or fluorinated itaconate co-monomer is included in place of, or in addition to, the non-fluorinated hardening monomer. Representative RGP materials are disclosed in U.S. Pat. Ser. Nos. 4,152,508 (Ellis et al.), 3,808,178 (Gaylord), 4,686,267 (Ellis et al.) and 4,780,515 (Deichert).

In one embodiment, the hydrogel pre-polymer mixture includes a solvent or diluent. Preferably, an organic diluent is included in the initial pre-polymer mixture. As used herein, the term “organic diluent” encompasses organic compounds that are substantially unreactive with the components in the initial mixture, and are often used to minimize incompatibility of the pre-polymer components in this mixture. Representative organic diluents include: monohydric alcohols, such as C₆-C₁₀ monohydric alcohols; diols such as ethylene glycol; polyols such as glycerin; ethers such as diethylene glycol monoethyl ether; ketones such as methyl ethyl ketone; esters such as methyl heptanoate; and hydrocarbons such as toluene.

Curing

Once the mold unit has been assembled it is subjected to a curing cycle, which polymerizes the pre-polymer inside the mold cavity. Typical contact lens curing methods involve exposing the pre-polymer mixture to light radiation (such as UV radiation or visible light) and/or thermal energy (e.g. oven curing).

De-Capping

Once curing is complete, the posterior mold section is separated from the anterior mold section to reveal the lens formed therein. The mold release process must break the adhesive bond between the mold sections, yet not damage the lens, which remains on one of the mold surfaces. In a preferred embodiment the lens remains upon the anterior concave optical surface at mold release and the annular lens flash remains or reservoir with the associated posterior mold section.

Solvent Removal

An optional step following de-capping is solvent removal. Unreacted solvent can be removed from the molded contact lens to further stiffen the lens. Preferably, solvents are volatile thus exposure to air at room temperature for a period of time will remove solvent. Nonetheless, a solvent can be removed in less time by placing the lens in an oven. After the solvent is evaporated from the lens, the lens is removed from the oven for additional processing. The step of solvent removal is preferably performed after the de-capping step and before reservoir removal. Optionally, the step of solvent removal can occur after reservoir removal, but before lens extraction.

Reservoir Removal

The manufacturing line may comprise a reservoir removal station to ensure the lens flash or reservoir is removed from the anterior mold section. The removal station may conveniently comprise a knife blade, which strips the annular lens flash or reservoir from the top of the mold section. Thus, immediately following mold release, the lens remains bonded to the concave mold surface and it is in the dry, rigid state.

Lens Release

Next, the lens is released from the mold half to which it is attached. The lens is released in a “wet release’ process by hydrating the lens. Generally, hydration occurs when the lens is immersed in a water bath. However, a wet release step at this stage prevents one or more additional processing steps including polishing and edging. Optionally, the lens is dry released (i.e. released from the mold without hydration of the lens) by applying a force angular to the axis of the contact lens and mold half to separate the contact lens.

In one embodiment, a super-cooled fluid (preferably a cryogenic fluid) is contacted with the lens or the mold half to release the lens from the mold half. The super cooled fluid creates a sudden temperature differential between the lens and the mold half that will break the bonding between the lens and the mold half. During, or immediately after the removal of the lens from the mold half that is assisted by application of the super-cooled fluid, the step of pre-polymer extraction, solvent extraction and/or lens cleaning occurs according to the present invention.

Alternatively, or additionally, the lens cleaning can occur at a later stage of processing. In one embodiment, the contact lens is dry released (including dry release assisted by application of a super-cooled fluid. Then, a step of edging and polishing occurs followed by a step of cleaning the lens, extracting solvent and/or extracting pre-polymer.

Edging/Polishing

In still another embodiment, the lens edge is optionally smoothed and polished. The smoothing of the lens removes lens fragments or portions of the lens reservoir that might adhere to the lens following reservoir removal and/or lens release. The polishing of the lens is generally known in the art and results in a lens that has improved edge surface for comfort. However, after edging and polishing, the lens will have debris in contact with the lens and will require cleaning.

Lens Cleaning/Pre-polymer Extraction

A cryogenic fluid is used in one embodiment of the present invention to clean the lens of debris and extract pre-polymer and/or solvent. Pre-polymer and or solvent is extracted from a polymer lens by contacting the lens with a super-cooled solvent for a period of time sufficient to extract pre-polymer from the polymer lens.

In one embodiment, the period of time is a minimum of about 0.1 seconds to a maximum of about 20 seconds. Typically, the period of time effective to clean the molding tool is a minimum of about 0.1 seconds, about 0.5 seconds, about 1.0 seconds, about 2.0 seconds or about 5.0 seconds. Typically, the period of time effective to clean the molding tool is a maximum of about 20 seconds, about 15 seconds, about 10 seconds, about 5 seconds, about 3 seconds, about 2 seconds, or about 1 second.

In another embodiment, the contacting occurs by immersing the contact lens in a bath containing the super-cooled fluid. Optionally, the contacting occurs by spraying the super-cooled fluid over the contact lens.

In still another embodiment, the super-cooled fluid is at a temperature below minus 40° C. when the super-cooled fluid is contacted with the lens. Typically, the temperature is below minus about 50° C., minus about 60° C., minus about 70° C. Typically, the super-cooled fluid is a cryogenic fluid.

In another embodiment, the process is selected from the group consisting essentially of nitrogen, argon, helium, and carbon dioxide. Preferably, the super-cooled fluid is an inert atmospheric gas. More preferably, the super-cooled fluid is nitrogen.

Typically, the extraction of pre-polymers occurs after the contact lens is removed from a mold that forms the contact lens. Optionally, the extraction of pre-polymers occurs while the lens is being released from a mold that forms the contact lens.

Washing and Hydration

After the inspection stage, the lenses proceed to a washing and/or hydration stage depending upon the type of lens. Typically, the lenses are supported on a carrier that supports a plurality of lenses in separate compartments e.g. 16, 32 etc. Optionally, the final packaging is used as the carrier during the washing and hydration step. In either instance, each lens is washed with purified water or in the case of hydrogel lenses hydrated with purified water until it has expanded to its full dimensions. Alternatively, the lens is washed or hydrated with a buffered saline solution in one or more washing steps. Water (or buffered saline solution) is extracted from the polymer matrix of the lens. Fresh water added to rinse the lenses. The lenses may be subjected to several rinses by extraction and addition of purified water. Preferably, a check is made to ensure the presence of a lens in a compartment after each extraction of water. It is believed that the previous step of pre-polymer extraction with a super-cooled fluid will reduce the number of stages of rinses with water or buffered saline solution.

Inspection and Packaging

Optionally, the lenses are inspected to identify lenses with optical defects. The inspection can be manual or automatic. If a lens fails the inspection test, it is deposited in a reject bin. If the lens passes the inspection test, the lens can be conveyed to the next processing step.

Transferred from the carrier into containers or blisters for final packaging the identity of the lenses is monitored via the carrier indicator. For example, the carrier identifier may be scanned as the carrier enters a processing station which will trigger the computer to provide the necessary information for printing a label or information directly on the lid stock which is applied to feel the blisters or containers. In general, applying a lid stock which is heat-sealed to the perimeter of the blister or container seals the blisters or containers.

Suitable lid stock comprises a laminate of metal foil on a polypropylene film. The lid stock may be printed e.g. by laser etching before or after its application to the container or blister. Alternatively, a label may be printed and applied to the lid stock before or after its application. The information printed on the lid stock or label may provide information for use by the end user or may be a machine readable identifier e.g. bar code, matrix code etc. to be used in later packaging operations. The labeling will provide sufficient information such that the lens in each blister or container may be identified in terms of its prescription and SKU, if necessary by interrogating the computer database. Thus, product integrity is ensured from inspection of the individual lens to its packaging in the blister or container.

Prior to application of the lid stock each blister or container is checked for the presence of a lens. After application of the lid stock the container or blister is examined for leaks and bad seals.

Thereafter, the packaged lenses are subjected to sterilization. The blisters or containers may be transferred to a tray or carrier for passage through the sterilization stage. The carrier is provided with a carrier indicator which is read and the information recorded in the computer memory so that the identity of the lenses and SKU is associated with the carrier indicator information.

After sterilization the lenses may be stored in a warehouse and cartoned and labeled in response to a specific order. Alternatively, the lenses may be cartoned and labeled to fulfill an order or for stockpiling ready for future orders.

What is claimed is:

1. A process for extracting pre-polymer from a polymer lens, the process comprising the step of contacting the lens with a super-cooled solvent for a period of time sufficient to extract pre-polymer from the polymer lens.

2. The process of claim 1, wherein the pre-polymer is a silicone containing pre-polymer.

3. The process of claim 1, wherein the pre-polymer is a hydrophilic pre-polymer.

4. The process of claim 1, wherein at least one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

5. The process of claim 1, wherein the period of time is a minimum of about 0.1 seconds to a maximum of about 20 seconds.

6. The process of claim 1, wherein the contacting occurs by immersing the contact lens in a bath containing the super-cooled fluid.

7. The process of claim 1, wherein the contacting occurs by spraying the super-cooled fluid over the contact lens.

8. The process of claim 1, wherein the super-cooled fluid is at a temperature below minus 40° C.

9. The process of claim 1, wherein the super-cooled fluid is selected from the group consisting essentially of nitrogen, argon, helium, and carbon dioxide.

10. The process of claim 1, wherein the step of contacting occurs after the contact lens is removed from a mold that forms the contact lens.

11. The process of claim 1, wherein the step of contacting occurs while the lens is being released from a mold that forms the contact lens.

12. A process for making a contact lens, the process comprising the steps of:
providing a mold comprising an anterior mold half and a posterior mold half;
filing the mold with a pre-polymer;
curing the pre-polymer to form a contact lens;
separating the anterior mold half from the posterior mold half;
removing the contact lens from one of the anterior mold half or the posterior mold half; and
contacting the contact lens with a cryogenic solvent for a period of time sufficient to extract pre-polymer from the contact lens.

13. The process of claim 12, wherein the pre-polymer is a silicone containing pre-polymer.

14. The process of claim 12, wherein the pre-polymer is a hydrophilic pre-polymer.

15. The process of claim 12, wherein at lest one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

16. The process of claim 12, wherein the period of time is a minimum of about 0.1 seconds to a maximum of about 20 seconds.

17. The process of claim 12, wherein the contacting occurs by immersing the contact lens in a bath containing the super-cooled fluid.

18. The process of claim 12, wherein the contacting occurs by spraying the super-cooled fluid over the contact lens.

19. The process of claim 12, wherein the super-cooled fluid is at a temperature below minus 40° C.

20. The process of claim 12, wherein the super-cooled fluid is selected from the group consisting essentially of nitrogen, argon, helium, and carbon dioxide.

21. The process of claim 12, wherein the step of contacting occurs after the contact lens is removed from a mold that forms the contact lens.

22. The process of claim 12, wherein the step of contacting occurs while the lens is being released from a mold that forms the contact lens.

23. The process of claim 12, wherein the step of contacting the contact lens occurs before the step of removing but after the step of curing.

24. A contact lens made by a process comprising the steps of:
polymerizing a contact lens from pre-polymer material; and
contacting the contact lens with a cryogenic solvent for a period of time sufficient to extract pre-polymer from the contact lens.

25. The process of claim 24, wherein the pre-polymer is a silicone containing pre-polymer.

26. The process of claim 24, wherein the pre-polymer is a hydrophilic pre-polymer.

27. The process of claim 24, wherein at lest one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

28. The process of claim 24, wherein the period of time is a minimum of about 0.1 seconds to a maximum of about 20 seconds.

29. The process of claim 24, wherein the contacting occurs by immersing the contact lens in a bath containing the super-cooled fluid.

30. The process of claim 24, wherein the contacting occurs by spraying the super-cooled fluid over the contact lens.

31. The process of claim 24, wherein the super-cooled fluid is at a temperature below minus 40° C.

32. The process of claim 24, wherein the super-cooled fluid is selected from the group consisting essentially of nitrogen, argon, helium, and carbon dioxide.

33. The process of claim 24, wherein the step of contacting occurs after the contact lens is removed from a mold that forms the contact lens.

34. The process of claim 24, wherein the step of contacting occurs while the lens is being released from a mold that forms the contact lens.

35. The process of claim 24, wherein the step of contacting the contact lens occurs before the step of removing but after the step of curing.

36. A process for cleaning a contact lens comprising contacting the entire surface of the contact lens with a cryogenic fluid.

37. The process of claim 36, wherein the step of contacting occurs for a period of time sufficient to remove particulate from the lens.

38. The process of claim 36, wherein the step of contacting occurs for a period of time sufficient to remove or destroy microbes from a lens.

39. The process of claim 36, wherein the pre-polymer is a silicone containing pre-polymer.

40. The process of claim 36, wherein the pre-polymer is a hydrophilic pre-polymer.

41. The process of claim 36, wherein at lest one pre-polymer is selected from the group consisting of amide monomers such as N,N-dimethylacrylamide and N,N-dimethylmethacrylamide; cyclic lactam monomers such as N-vinyl-2-pyrrolidone; (meth)acrylated alcohol monomers, such as 2-hydroxyethylmethacrylte and 2-hydroxyethylacrylate; (meth)acrylated poly(alkene glycol) monomers, such as poly(diethylene glycol) monomers of varying chain length containing monomethacrylate or dimethacrylate; hydrophilic vinyl carbonate monomers; hydrophilic vinyl carbamate monomers; and hydrophilic oxazolone monomers.

42. The process of claim 36, wherein the period of time is a minimum of about 0.1 seconds and a maximum of about 20 seconds.

43. The process of claim 36, wherein the contacting occurs by immersing the contact lens in a bath containing the super-cooled fluid.

44. The process of claim 36, wherein the contacting occurs by spraying the super-cooled fluid over the contact lens.

45. The process of claim 36, wherein the step of contacting further includes contacting the surface of the contact lens with a turbulent super-cooled fluid.

46. The process of claim 36, wherein the super-cooled fluid is at a temperature below minus 40° C.

47. The process of claim 36, wherein the super-cooled fluid is selected from the group consisting essentially of nitrogen, argon, helium, and carbon dioxide.

48. The process of claim 36, wherein the step of contacting occurs after the contact lens is removed from a mold that forms the contact lens.

49. The process of claim 36, wherein the step of contacting occurs while the lens is being released from a mold that forms the contact lens.

50. The process of claim 36, wherein the step of contacting the contact lens occurs before the step of removing but after the step of curing.

51. A process for manufacturing a contact lens, comprising the steps of:
forming the contact lens in a mold;
removing the contact lens from the mold; and
contacting the entire surface of the contact lens with a super-cooled fluid.
